(19) United States
(12) Patent Application Publication
(10) Pub. No.: US 2013/0276827 A1
(43) Pub. Date: Oct. 24, 2013

(54) BRUSH AND MACHINE FOR REMOVING CHEWING GUM REMAINS AND WEEDS FROM SURFACES AND CREVICES

(71) Applicants: Marc Delaere, Lochristi (BE); Christiaan De Clerck, Lochristi (BE)

(72) Inventors: Marc Delaere, Lochristi (BE); Christiaan De Clerck, Lochristi (BE)

(21) Appl. No.: 13/997,597

(22) PCT Filed: Dec. 26, 2011
(86) PCT No.: PCT/IB11/03163

§ 371 Date: Jun. 24, 2013

(30) Foreign Application Priority Data
Dec. 24, 2010 (BE) 2010/0765

(51) Int. Cl. B08B 1/00; A46B 13/00; A46B 9/06

(52) U.S. Cl. CPC B08B 1/002; A46B 9/06; A46B 13/00
USPC 134/6; 15/207.2; 15/21.1

(57) ABSTRACT

a brush for removing chewing gum remains and weeds from a surface (12), consists of a baseplate (4) provided with first hairs (1) and one or more detachable brush parts (5) provided with second hairs (2), in which the second hairs (2) extend beyond the first hairs (1) at the cleaning surface (11), and in which one or more first (1) or second hairs (2) are steel strips or wires having a serrated or toothed edge and/or tip. A machine for removing chewing gum remains has at least one such brush and is provided with a heating chamber (13) for heating chewing gum remains before the brush (10) moves across the surface. A method for removing chewing gum uses such a brush (10) or such a machine.

The invention relates to a brush for removing chewing gum remains and weeds from a surface and in a crevice, consisting of a baseplate provided with at least one set of first hairs and one or more detachable brush parts provided with at least one set of second hairs, in which the first and second hairs form such a cleaning surface that the second hairs are longer than the first hairs at the cleaning surface.

The invention also relates to a machine for removing chewing gum remains which is designed to be moved across the surface and which comprises one or more brushes which are designed to move when touching the surface.

The horizontal or vertical surface to be cleaned may be provided with grooves, crevices, uneven structures and/or pores.

Furthermore, the invention relates to a method for cleaning surfaces which are provided with grooves, crevices, uneven structures and/or pores, and in particular for removing chewing gum remains by means of such a brush or such a machine.

Stuck chewing gum remains in public places, such as shopping centres, footpaths and squares are seen as a social problem as are weeds in crevices. Due to the water-repellent nature of chewing gum, it is difficult to remove from the surface.

Until now, there is no efficient, environmentally friendly and sustainable solution to remove chewing gum and weeds from asphalt, concrete, paving stones, natural stone, metal floors or other elements and surfaces.

In a known method, each chewing gum is separately and individually heated by means of steam in order to then remove it from the surface using a chemical product and/or a steel brush (5 cm in diameter).

Another method is to use water from a high-pressure hose by means of which each chewing gum is removed from the surface separately.

Yet another method is a combination of hot water, steam under high pressure. This method uses powerful jets of steam at 178° C. and a pressure of 8 bars and a small metal brush in order to remove each chewing gum separately and individually. In certain circumstances, chemicals are used as well. In another method, the steam is replaced by jets of dry ice or liquid nitrogen as a result of which the individual chewing gum becomes very brittle and can be more readily removed from the surface.

When cleaning surfaces using high pressure or chemical products, they are sprayed with a water jet, sand jet and/or a water/sand jet at high pressure (from 120 bars). During chemical cleaning, chemical products are applied to the surfaces. The chemical products act on the dirt which is present. At the end of the soaking period, any dirt is sprayed off together with the chemical products.

However, each of these methods has significant drawbacks. A first drawback is that the chewing gum is treated separately, thus making it a very labour-intensive and therefore expensive operation. The use of chemical products is not environmentally friendly. Removing chewing gum by means of steam or water at high pressure has adverse effects on the surface. The surface becomes porous, as a result of which it becomes soiled more quickly and eventually breaks. The use of steam at 178° C., jets of dry ice (CO₂ ice granules of −79° C. at a pressure of 2-10 bar) or liquid nitrogen (−196° C.) is very dangerous and requires large amounts of energy. As no thorough cleaning of the grooves, crevices, uneven structures and/or pores between the surfaces takes place, chewing gum remains which are situated in between are difficult to remove.

BE 1017134 in the name of the Applicant describes a brush for a scrubbing, brushing and/or polishing machine for machine-cleaning several surfaces which are separated from one another by means of grooves and/or crevices, in which said scrubbing, brushing and polishing machine is provided with one or more brushes which comprise at least one set of polishing hairs for cleaning and/or polishing of the surfaces, and at least one set of crevice hairs for cleaning the grooves and/or the crevices between the surfaces, in which the polishing hairs have a length which is smaller than the length of the crevice hairs, and which discloses a machine which is provided with one or more such brushes.

However, one drawback of this brush is the fact that the crevice hairs wear down and become as short as the polishing hairs of the brush, as a result of which it is no longer possible to clean grooves, crevices, uneven structures and/or pores with this brush.

BE 1018211 in the name of the Applicant describes an improved brush in which the brush comprises a baseplate which, on the one hand, is provided with directly inserted polishing hairs and, on the other hand, is designed for removably attaching one or more modular brush parts which are provided with one or more sets of longer crevice hairs.

In a particular embodiment, the crevice hairs are provided with metal hairs for removing stubborn soiling, such as moss, lichen, paint (inter alia graffiti), concrete smears and oils. In another embodiment, the cores of the hairs of the first and/or second sets are reinforced by means of metal wire or steel.

However, it is a drawback of this brush that these simple metal hairs or hairs reinforced with metal wire are not sufficiently strong for the efficient removal of chewing gum remains. The hairs wear down too quickly or start to deform and fray.

It is therefore an object of the invention to provide an efficient brush for removing chewing gum remains and weeds from surfaces which does not have the above-mentioned drawbacks.

The object of the invention is achieved, on the one hand, by providing a brush for cleaning chewing gum remains and weeds from a surface and in a crevice, consisting of a baseplate provided with at least one set of first hairs and one or more detachable modular brush parts provided with at least one set of second hairs, in which the first and second hairs form such a cleaning surface that the second hairs are longer than the first hairs at the cleaning surface, in which one or more first or second hairs are steel strips or wires having a toothed or serrated edge and/or tip.

The use of steel wires or strips with a serrated edge and/or tip ensures an effective cleaning operation in which chewing gum remains and other dirt is removed more quickly and more thoroughly. These wires or strips also catch and completely remove grass and weeds which grow in the crevices of the surface to be cleaned. This makes it possible to design the wires or strips in such a manner that they are sufficiently flexible not to damage the surface.

Such a brush according to the invention may be configured in such a manner that, compared to the known systems, the following advantages are achieved:
the brush can be designed to have a larger diameter;
the speed with which chewing gum is cleaned and removed is faster;
several chewing gums can be removed simultaneously;
the treated surface is not damaged;
less energy is used, as the required temperatures of the water or the steam are lower;
more environmentally friendly since no chemicals are used;
not dangerous to the user as no liquid nitrogen or jets of dry ice are used and work is not carried out at high pressure (thus preventing the risk of so-called shot wounds)
more cost-efficient cleaning of surfaces;
less complicated and less expensive cleaning equipment.
the “Terrazza MC” multibrush system for weed management in public spaces which was developed by the Applicant can take several brushes at once, making it possible to clean several thousand square metres per day.

In a preferred embodiment of the brush according to the present invention, the wires with a serrated edge and/or tip are braided or wound wires. In this case, the same or different kinds of wire or material may be twisted together in order to enhance certain mechanical, physical or chemical properties.

In another very efficient embodiment, said strips are made from card wire, preferably card wire as described in WO 2010/016872.

In a preferred embodiment of a brush according to the invention, at least one set of second hairs of the detachable brush parts comprises steel strips or wires. Preferably, all modular brush parts of a brush according to the invention comprise steel strips or wires.

In a preferred embodiment of a brush according to the invention, the strips or wires have a width of 2 to 10 mm, preferably 2 to 5 mm. The strips are preferably made from steel with one of the following carbon contents: C60, C75 or C100, or from a steel alloy, such as for example 10Cr6. The steel may have undergone an aftertreatment, such as hardening. The strips may contain titanium or tungsten or an alloy thereof.

The strips are preferably made from stainless steel.

In yet another embodiment, the strips are wires of different geometries, such as for example strips or wires having a round, oval or triangular cross section. In yet another embodiment, the strips or wires may be braided or wound wires.

The steel alloy may furthermore also contain manganese (Mn) and silicon (Si), but also chromium (Cr), vanadium (V), nickel (Ni) and/or molybdenum (Mo).

In a particular embodiment, the steel strips or wires are provided with a coating layer or coating. Such coating layers comprise, for example, tungsten carbide, nickel, chromium, zinc or plastic. The advantages of such coating layers are an increase in, inter alia, the strength, resistance to wear, flexibility and resistance to breaking.

The strips or wires are preferably attached to the baseplate or to the brush parts by means of through-holes which are provided in the baseplate or brush parts. In a particular embodiment, the strips are inserted into the holes of the baseplate and/or the brush parts cross-wise. They may also be inserted radially or tangentially or as a combination thereof.

In a preferred embodiment of a brush according to the invention, the brush parts are L-, T- or Y-shaped. The expression L-shaped is intended to mean a shape in which a brush part consists of a first brush part and a second brush part which is at right angles to the first brush part at one end thereof. The expressions T- and Y-shaped are to be interpreted analogously.

In a particular embodiment, the detachable brush parts are provided on the baseplate in such a manner that they extend radially between the sets of first hairs. This means that the longest or most central leg of the brushes (e.g. being L-, T- or Y-shaped) is oriented radially on a round baseplate.

In another embodiment, the detachable brush parts are provided on the baseplate in such a manner that they extend between the sets of first hairs in a way similar to the shape of blades.

In yet another particular embodiment, the detachable brush parts are movably arranged with respect to the baseplate. In this case, the detachable brush parts can be moved in a rotating or reciprocating manner with respect to the baseplate while the baseplate is also carrying out a rotating movement at the same time.

In a preferred embodiment of a brush according to the invention, two, three or four detachable brush parts are provided on the baseplate. In this case, the brush parts are evenly distributed between the first hairs of the baseplate.

In yet another preferred embodiment of a brush according to the invention, at least part of the first or the second hairs, respectively, are inserted obliquely into the baseplate or the brush parts, respectively. By directing the hairs obliquely to the outer edge of the baseplate, chewing gum remains which are situated in the comers of a nearly horizontal surface and a vertical wall can be removed effectively.

In another embodiment of a brush according to the invention, said brush comprises supply means for supplying hot water or steam, preferably at low pressure, to the surface to be cleaned. This supply is preferably effected through the baseplate. In another embodiment, the supply means may be provided for applying edge spraying.

In yet another embodiment, a brush according to the invention may be provided with means to carry out a heating, cooling or freezing pretreatment (if desired via edge spraying) for removing chewing gum remains in an even more efficient manner. This pretreatment preferably comprises a laser or microwave pretreatment, or comprises a treatment with dry ice.

In a particular embodiment of a brush according to the invention, one or more connecting pieces are provided for fitting between the baseplate and a brush part. The baseplate is preferably of round design.

According to a second aspect of the present invention, a machine for removing chewing gum remains is also provided with a surface to be cleaned.

Said machine is designed to be moved across the surface and comprises one or more brushes which are designed to move when touching the surface, in which said machine according to the invention comprises a heat source which is designed to heat the chewing gum remains which are situated on the surface in front of the brushes, viewed in the direction of movement, during the movement of the machine.

By way of example, this relates to a scrubbing, brushing and/or polishing machine. In this case, said machine may be driven electrically, hydraulically, pneumatically or otherwise. This includes, on the one hand, large professional cleaning machines provided with wheels, but also includes, on the other hand, any do-it-yourself appliances to which a brush of this type, albeit smaller, can be fitted, such as for example an electric drill.

The machine according to the present invention preferably also comprises metal strips or wires in combination with means for heating said strips or wires. As a result thereof, chewing gum remains come into contact with the heated brush hairs during cleaning, thus causing an additional heating of the chewing gum which in turn results in an even quicker removal.

Said machine preferably comprises hairs which are steel wires or strips. In a more preferred embodiment, these steel strips or wires have a toothed or serrated edge and/or tip.

The brush hairs preferably consist of first and second hairs which form a cleaning surface in which the second hairs extend beyond the ends of the first hairs. The second hairs can then also be provided on detachable brush parts, thus producing a modular brush. Furthermore, the brush may also have one or more of the above-described features of the brush according to the present invention.

The machine is preferably designed to machine-clean several surfaces which are separated from one another by means of grooves, crevices, uneven structures and/or pores, such as inter alia paving stones, cobblestones, natural stone, tiles, bricks, rendering, asphalt concrete (ZOA, ZOAB) and/or metal and/or wood. One or more modular brushes according to the invention can be fitted to such a machine.

In this case, said machine is preferably designed to move said modular brushes in a plane which is substantially parallel to the surfaces which are separated from one another.

While the machine moves, a heat-pretreatment is applied during which chewing gum remains are heated just before the toothed or serrated steel wires or strips are moved across the surface. Said pretreatment is preferably designed to heat the chewing gum remains up to a temperature at which the chewing gum is soft.

A particularly efficient and user-friendly machine according to the present invention comprises a heating chamber which is at least partly open on the side facing the surface, while the heat source is designed to heat the air in the heating chamber or to introduce heated air into said heating chamber, and while the heating chamber is provided on the front of the machine with respect to the brushes so that the open side is situated above a part of the surface which is situated in front of the brushes during the movement of the machine.

The heat source may also be designed to heat the surface to be cleaned and the chewing gum remains thereon directly, without heating or while only slightly heating the air in the heating chamber.

The heat source may be an electric resistor or a gas burner. Preferably, a blowing device is also provided. Other heat sources, such as infrared radiation or microwaves, are obviously also possible. Also combinations of two or more of these heat sources are possible.

Preferably, the heating chamber comprises side walls, the end parts or edge parts of which facing the surface are made from a flexible material, or are provided with a plurality of flexible elements, such as brush hairs which extend towards the surface to be cleaned. The flexible material is, for example, rubber or a flexible plastic. The flexible edge parts or flexible elements surround the heating chamber and if there are uneven structures or obstacles on the surface to be cleaned, these will only elastically deform the flexible edge sections or the flexible elements, but not damage them and will not prevent the machine from moving on.

A most preferred machine according to the present invention is achieved if this is fitted with at least one brush with steel strips or wires having a toothed or serrated edge and/or tip. The heated chewing gum remains are soft and are then removed very efficiently by the toothed or serrated strips or wires immediately after having been heated. In the meantime, the entire surface is also thoroughly cleaned by the brush. This ensures that no stains remain in the spots where the chewing gum remains were. The latter is also a significant advantage of the machine according to the invention compared to known machines and methods of removing chewing gum remains.

Finally, the present invention also provides a method for removing chewing gum remains from a surface to be cleaned, in which one or more brushes comprising steel strips or wires having a toothed or serrated edge and/or tip according to the invention are used, or in which a machine according to the invention is used.

A more detailed description of the various preferred embodiments of a brush according to the invention is now given in order to explain the characteristics of the present invention and to indicate additional advantages and features thereof.

Furthermore, some of these embodiments are discussed in the attached figures, with reference numerals being used to refer to these figures, in which:

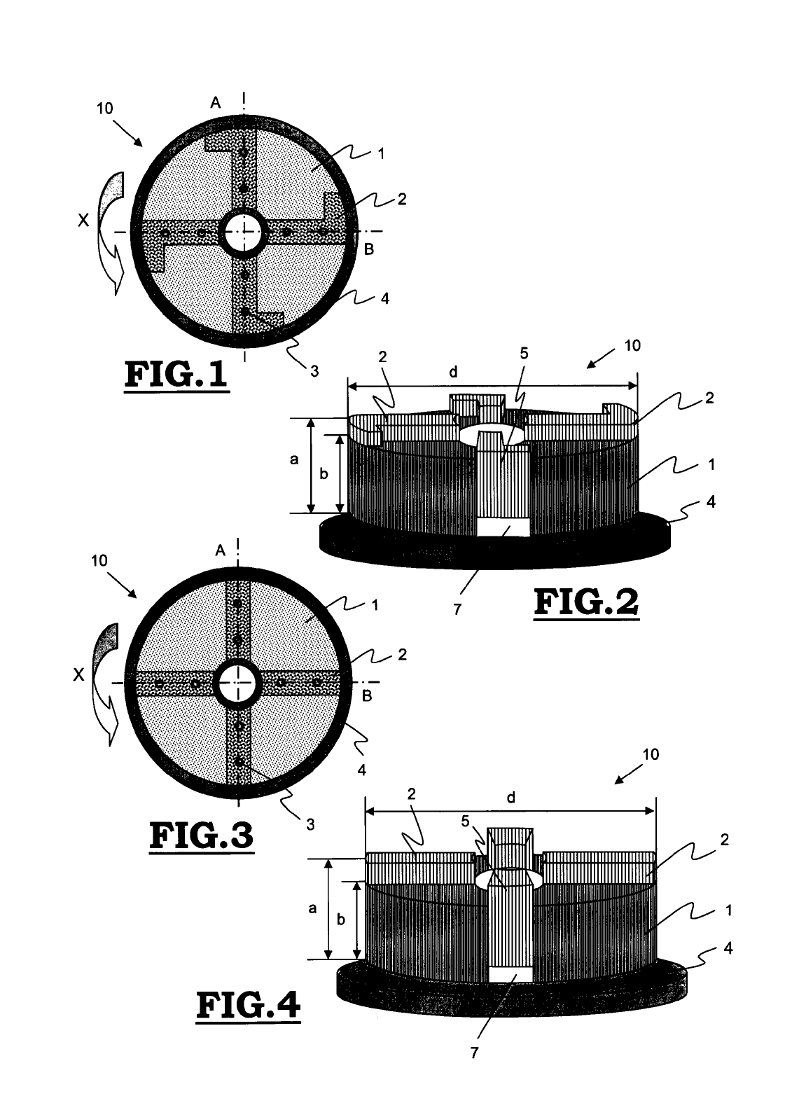

FIG. 1 shows a top view of a first embodiment of a modular brush for a machine for horizontally and/or vertically cleaning surfaces which are provided with grooves, crevices, uneven structures and/or pores according to the invention;

FIG. 2 shows a perspective front view of the first embodiment as illustrated in FIG. 1;

FIG. 3 shows a top view of a second embodiment of a modular brush for a machine for horizontally and/or vertically cleaning surfaces which are provided with grooves, crevices, uneven structures and/or pores according to the invention;

FIG. 4 shows a perspective front view of the second embodiment as illustrated in FIG. 3;

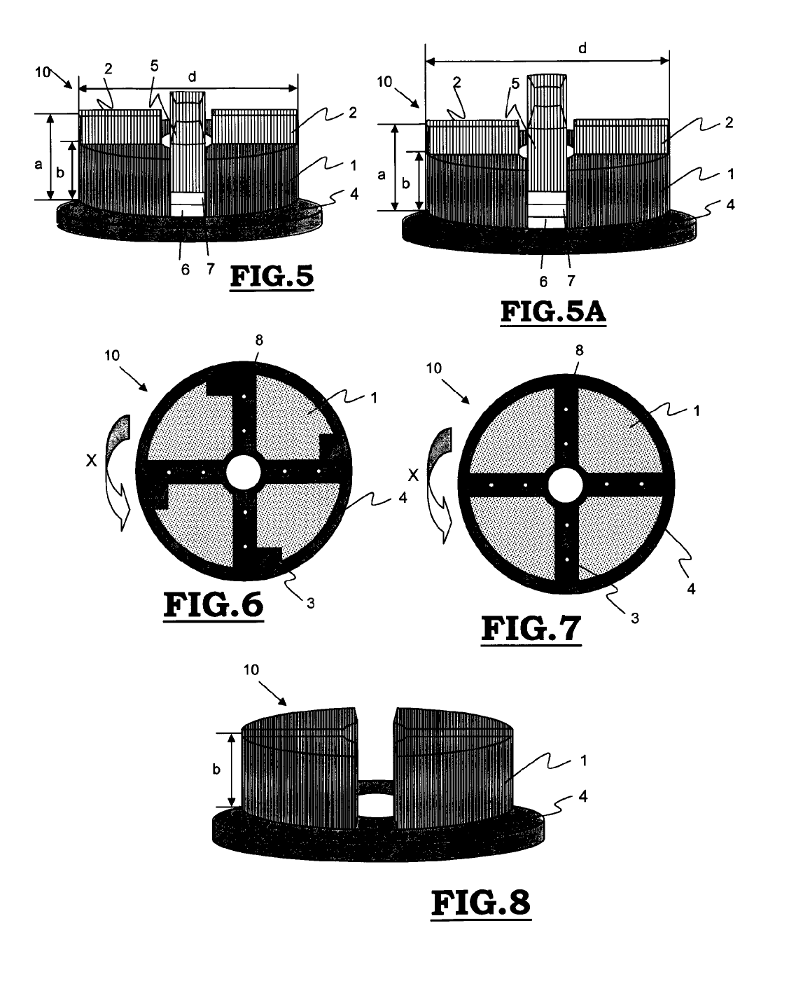

FIG. 5 shows a perspective front view of the second embodiment as illustrated in FIGS. 3 and 4, in which a connecting piece is fitted between the bases of the modular brush parts and the baseplate of the brush;

FIG. 5A shows a perspective front view of the second embodiment as illustrated in FIGS. 3 and 4, in which 2 connecting pieces are fitted between the bases of two of the modular brush parts which are in line with one another and the baseplate of the brush;

FIG. 6 shows a top view of the first embodiment of the brush as illustrated in FIGS. 1 and 2 without the modular brush parts;

FIG. 7 shows a top view of the second embodiment of the brush as illustrated in FIGS. 3, 4 and 5 without the modular brush parts and connecting pieces;

FIG. 8 shows a perspective front view of the brush without modular brush parts as illustrated in FIG. 7;

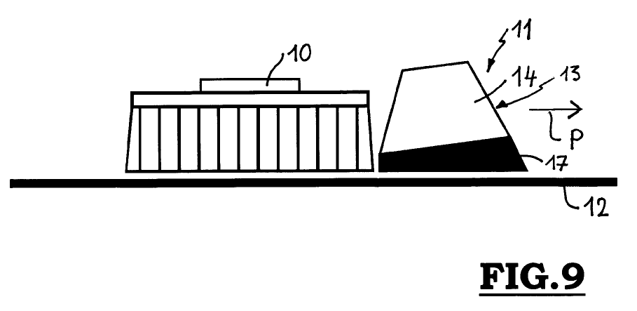

FIG. 9 shows a diagrammatic side view of a cleaning machine with a brush and a pretreatment unit according to the invention; and

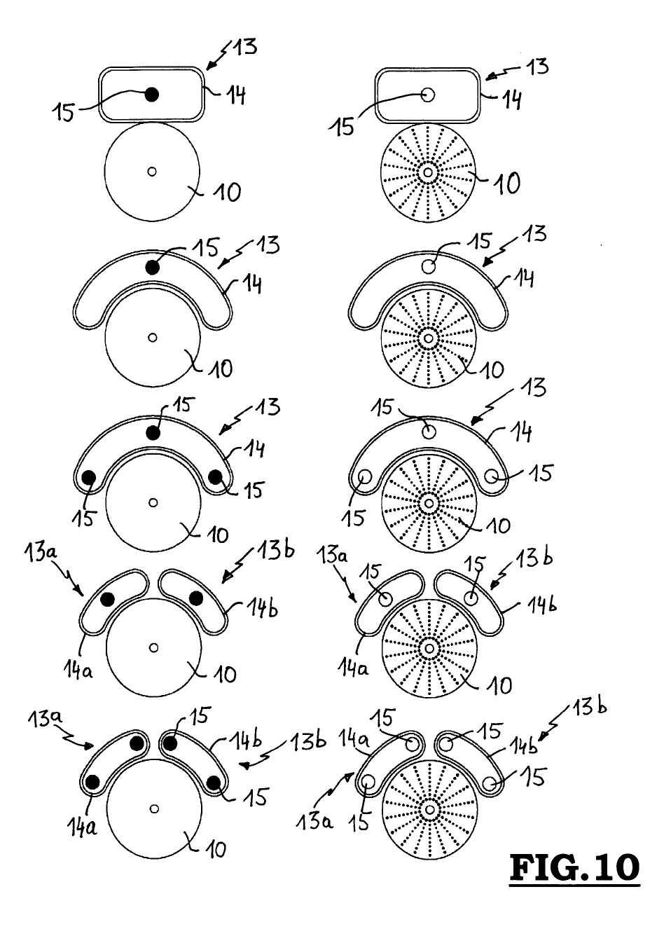

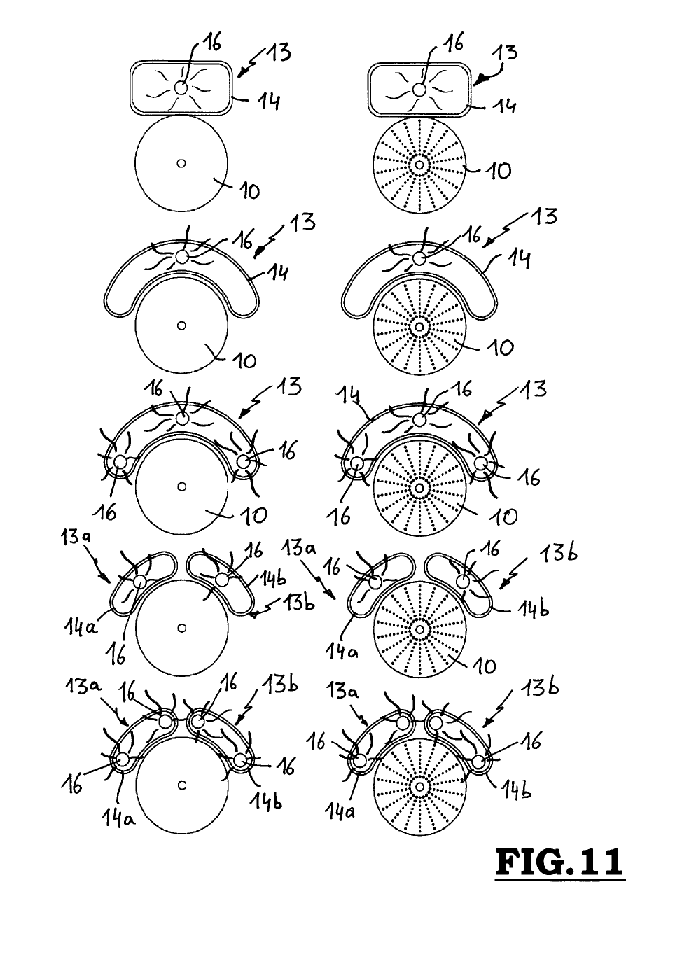

FIGS. 10 and 11 diagrammatically show in top view (left) and bottom view (right) various embodiments for the heating chamber with respect to a round brush.

Such a modular brush (10) preferably comprises a round baseplate (4) which is provided with at least one set of first hairs (1) which are directly inserted into said baseplate (4). Furthermore, said modular brush (10) comprises one or more modular brush parts (5) which are designed in order to be removably attached to the baseplate (4) by means of one or more bolt or screw connections, and which are provided with on one or more sets of second hairs (2) which are inserted on a modular base (7), said second hairs (2) being provided for cleaning the grooves, crevices, uneven structures and/or pores between the surfaces which are separated from one another. Other methods of connecting the modular brush parts to the baseplate are possible in order to raise and/or replace the modular brush parts more efficiently.

In this case, these sets of first and second hairs (1,2) form a cleaning surface, in which the second hairs (2) protrude with respect to the first hairs (1) at this cleaning surface in order to enable cleaning of grooves, crevices, uneven structures and/or pores.

The baseplate (4) preferably comprises two or more sets of first hairs (1) which are directly inserted into the baseplate (4), in which, between the two sets of first hairs (1), there is a zone (8) which is free from first hairs (1) and which is provided for the attachment of the brush parts (5) into which the second hairs (2) are inserted.

The zones containing first hairs (1) preferably have a shape which complements the shape of the zones containing second hairs (2).

In the preferred embodiments of a modular brush (10) according to the invention, in the assembled state of the brush (10), four modular brush parts (5) are provided which are in line with one another in pairs (fictitious lines A and B). In the preferred embodiments of a modular brush (10) according to the invention, these two lines (A, B) are at a right angle to one another (in other words, the angle between these two lines (A, B) is virtually 90° or these two lines (A, B) are perpendicular to one another). In case three modular brush parts are fitted, these are preferably fitted at an angle of 120 degrees.

The modular brush parts (5) may be L-shaped or, in other words, these may have an end with a brush section which is situated at right angles to the rest of the modular brush part (5). The zones with first hairs (1) which have been directly inserted into the baseplate (4) in this case preferably have a shape which complements this L shape. However, the modular brush parts (5) may also be T- or Y-shaped, in which case, for example, the short legs of the T or Y shape are facing the edge of the brush.

In relation to the above, it should be noted that it is also possible to provide more or fewer modular brush parts (5), that the modular brush parts (5) and/or the zones with first hairs (1) may have a different shape and that the first and second hairs (1,2) may also be arranged in another suitable configuration.

As is illustrated in FIGS. 5 and 5A, connecting pieces (6) may be fitted between the baseplate (4) and the modular base (7) of a brush part (5).

These connecting pieces (6) are particularly advantageous when the second hairs (2) of one or more brush parts have worn down to such an extent that they no longer protrude with respect to the cleaning surface. In this way, it is not necessary to replace the entire brush part, but it is possible to make these second hairs (2) protrude sufficiently far again with respect to the cleaning surface by inserting such a connecting piece (6) between the modular base (7) and the baseplate (4).

In addition, these connecting pieces (6) are also particularly advantageous when the distance by which the second hairs (2) protrude with respect to the first hairs (1) at the cleaning surface has to be different in the case of two or more of the brush parts (5) (as is illustrated in FIG. 5A) in order to be able to clean certain types of surfaces better. Such a configuration is very advantageous, for example, in order to efficiently remove rubber from of a surface to be cleaned.

In this case, these connecting pieces (6) have the same shape as the modular brush parts (5).

The round baseplate (4), the modular bases (7) and the connecting pieces (6) are provided with openings (3) for attaching these modular brush parts (5) and the connecting pieces (6) to the baseplate (4). These openings (3) preferably extend through the thickness of the baseplate (4), the modular bases (7) and the connecting pieces (6) in such a manner that the removable attachment of the brush parts (5) and the connecting pieces (6) to the baseplate (4) can be effected by means of a bolt or screw and nut connection.

The modular brush (10) according to the invention preferably has a diameter (d) which varies between approximately 5 cm and approximately 60 cm.

The second hairs (2) and first hairs (1) may be made from a different material or may have different physical and mechanical properties. The hairs (1,2) may, for example, be made from plastic, for example from polypropylene, or from nylon or from polyester and/or from metal, preferably from steel having a diameter of approximately 300 μm.

The composition of the hairs of the modular brush (10) is preferably as follows:
the second hairs (2) protruding with respect to the cleaning surface are completely or partially made from metal, C60, C75, C100, steel alloy (such as 102Cr6). The hairs may be completely or partially coated with, inter alia, chromium, tungsten carbide, zinc, nickel or plastic. These hairs may also have undergone an aftertreatment, such as hardening. These second hairs (2) have a length (a) which varies between approximately 4 cm and approximately 12 cm, and have a diameter which varies between approximately 0.3 mm and approximately 1.2 mm. These second hairs may be round, oval or triangular and are preferably strip-shaped. These hairs (2) first of all ensure that stubborn chewing gum remains and weeds are ripped from the surface or from the crevices.
the shorter first hairs (1) are preferably made from plastics, steel or stainless steel. These first hairs (1) have a length (b) which varies between approximately 3 cm and approximately 11 cm, and have a diameter which varies between approximately 0.3 mm and approximately 1.5 mm. These first hairs (1) have a good polishing and scrubbing effect on the surfaces in order to remove the chewing gum remains completely.

The round baseplate (4) is preferably made from plastic, more preferably from polypropylene, and has a thickness of approximately 2.5 cm.

The modular bases (7) into which the second hairs (2) are inserted are preferably made from plastic, more preferably from polypropylene, and preferably also have a thickness of approximately 20 mm. The connecting pieces which are placed between the baseplate (4) and the modular base (7) of a brush part (5) are preferably made from plastic, more preferably from polypropylene having a thickness of approximately 10 mm.

The operating procedure for removing chewing gum remains on both a horizontal and a vertical surface consisting of several surfaces which are separated from one another by grooves, crevices, uneven structures and/or pores, such as inter alia paving stones, cobblestones, natural stone, tiles, brick, rendering, road paving (ZOA, ZOAB) and/or metal and/or wood, is as follows:
unloading the machine, modular brushes (10), garden hose and the other requisites;
fitting the modular brush(es) (10) on the machine, connecting the garden hose to the boiler, connecting a water hose between the boiler and the scrubbing/polishing machine or the edge sprayer, opening the water supply and switching on the machine;
making the modular brush(es) (10) rotate (direction of rotation X) and pushing the machine across the surface to be cleaned, as a result of which
   the upper surface of the paving stones, cobblestones, natural stone, tiles, brick, rendering, road paving (ZOA, ZOAB) and/or metal and/or wood, is cleaned;
   the lateral surface of the paving stones, cobblestones, natural stone, tiles, brick, rendering, road paving (ZOA, ZOAB) and/or metal and/or wood, is cleaned;
   the grooves, crevices, uneven structures and/or pores which are situated between the paving stones, cobblestones, natural stone, tiles, brick, rendering, road paving (ZOA, ZOAB) and/or metal and/or wood are cleaned;
at a constant speed of approximately 103 s/m². Very dirty spots can be given extra attention due to the easy-to-use modular brush(es) (10) according to the invention, i.e. it is possible to exert more or less pressure on the modular brush(es) (10);
rinsing the cleaned surface using the spraying device;
with paving stones, cobblestones; refilling the crevices with new sand. This can be done using the same machine (scrubbing, brushing, polishing machine), but with a brush which is provided with soft hairs having an equal length of approximately 4.5 cm. By using such a brush, the sand is pushed into the crevices. Moreover, this sand additionally polishes the paving stones, cobblestones which results in a more attractive appearance and the removal of the remaining chewing gum remains.
clearing away the machine, modular brush(es) (10), garden hose and other requisites used.

### Test Results

Tests using the standard modular brush (BE 2006/0266 and BE-2008/0376) show good results with regard to dirt removal. The standard round brush consists of a brush plate provided with at least one set of polishing hairs for cleaning or polishing the surfaces and at least one set of crevice hairs inserted into detachable brush parts for cleaning the grooves and/or crevices between the surfaces. These detachable brush parts are fitted to the brush plate in the openings provided.

At the cleaning surface, the crevice hairs protrude with respect to the polishing hairs. The polishing hairs are made of plastic and the crevice hairs are made of plastic and/or metal. This standard brush cleans the surface and the crevices at the same time. The dirt from the crevices and the small amount of water which is introduced in the centre of the brush form the abrasive by means of which the surface is cleaned by the polishing hairs.

In the present invention, the crevice hairs of at least one of the detachable brush parts are replaced by steel strips. It is possible to insert one or more strips per opening in a brush part. These strips can be inserted in various ways (parallel to one another, in separate cross bond or crossing one another) in the detachable brush part.

The strips may have different shapes. The strips may, for example, have a thickness of 0.5 mm, a width of 3 mm and a length of 22 mm, they may be triangular or round, or they may be toothed (on one or two sides of the strips).

The steel may have different compositions, for example C60, C75, C100, 102Cr₆, or it may also be nickel-plated or chrome-plated or be subjected to any other advantageous treatment. Each combination has its own particular characteristics regarding breaking, wear, corrosion and efficiency in the removal of chewing gum remains or other soiling. Thus, tests have shown that C75 steel is a good compromise between resistance to wear and resistance to breaking. Other advantageous materials are stainless steel.

Cross-wise positioning of the steel strips in the modular steel blocks gives good results.

The effect of using steel strips is very clear; stubborn dirt, such as chewing gum remains, lichen and weeds, is removed more quickly than when using the brush with plastic or metal hairs, without damaging the cleaned surface. The surfaces which were cleaned include paving stones (concrete and clay), cobblestones, tiles, sandstone, blue stone, bangkirai, . . . The small amount of water which was introduced in the centre of the brush acts as a lubricant.

Tests using 2, 3 and 4 detachable brush parts consisting of steel strips (C75 steel) have shown that they do not damage the cleaned surface. Extensive tests were carried out on natural stone which is susceptible to scratching, such as French sandstone. A comparative test was carried out on a platform made of natural stone at Antwerp central railway station. A cleaning test using the brush with 3 detachable brush parts fitted with steel strips and a cleaning test using hydrochloric acid. The results for the brush with 3 detachable brush parts fitted with steel strips are as good if not better than those of cleaning with hydrochloric acid (HCl). Over time, the hydrochloric acid will have a negative effect on the surface of the natural stone.

Tests carried out using a brush with several detachable brush parts fitted with steel strips have shown that the latter can efficiently remove chewing gum from a paving stone surface. A small amount of water/steam at 100°°C. (atmospheric pressure) is introduced at the centre of the brush during cleaning. The surface and the crevice are cleaned and any chewing gum present is removed without damage to the surface.

The brush according to the invention also brings very favourable results for clearing snow and, more specifically, for removing black ice on, for example, footpaths and cycle paths. The current snowploughs cannot remove black ice, because the scraper cannot get sufficiently close to the ground, since there is then a risk of damage to the road surface or the machines. The brush of the invention rests on the ground and brushes the black ice away without damaging the surface. If desired, it is possible to use additional salt, grit or other defrosting or de-icing means with the brush during removal.

FIG. 9 diagrammatically shows a side view of a machine for cleaning away chewing gum remains from a surface (12), provided with a brush (10) according to the invention and a pretreatment unit (11) which is attached to the brush device or forms part of it.

The pretreatment unit (11) comprises (see FIGS. 10 and 11) a heat source (15), (16), such as for example a hot-air blower, with an electric resistor or a gas burner, or any other known heat source (such as infrared lamps or a microwave or laser-heat source) or a combination of two or more of these heat sources.

The pretreatment unit (11) is situated on the front of the cleaning machine with respect to the brush (10), so that a surface (12) to be cleaned is always first heated by the pretreatment unit (11), before it is cleaned by the brush (10) while the machine (11) moves in the direction of movement (P).

The pretreatment unit (11) comprises a heating chamber (13) which is bounded by closed side walls (14) and which has an open bottom side. The upper side of the heating chamber (13) is closed. Said heat source (not shown in FIG. 9) is arranged in the interior which is surrounded by the side walls (14). The side walls (14) are made from metal or from a heat-resistant plastic.

The bottom edges of these side walls (14) are situated at a slight distance above the surface to be cleaned. A bottom section (17) of the side walls (14) is preferably made from an elastically deformable material in order to prevent the movement of the machine from being blocked by uneven structures on the surface to be cleaned or obstacles and in order to prevent damage by such uneven structures or obstacles as much as possible. This makes it possible to displace the heating chamber at a very small distance above the surface to be cleaned. In FIG. 9, this bottom flexible section (17) is illustrated diagrammatically as a black surface.

Due to the fact that the bottom edges of the side walls (14) can thus be at a very small distance above the surface to be cleaned, the gap between the surface (12) and these bottom edges can be very narrow, so that little heat escapes via this gap. The chewing gum remains which are situated on the surface can be heated very quickly to a temperature at which they become soft and can easily be removed by the brush (10) of the machine which moves across the surface very quickly thereafter.

The heating chamber (13) is, for example, in the shape of a pyramid with a square or rectangular base which is open.

FIGS. 10 and 11 diagrammatically show various other arrangements and configurations for the heating chamber in top view (left) and bottom view (right).

In each case, the open bottom side of the heating chamber (13) can be seen which is situated in front of the round brush (10), viewed in the direction of movement (P) of the machine.

In FIG. 10, the heat source is a hot-air blower (15) which is diagrammatically shown as a black circle (in top view) or a clear circle (in bottom view). On the bottom view, the brush hairs which are shown diagrammatically as dots can also be seen.

The configurations of FIG. 11 and FIG. 10 are identical. The only difference is that in the embodiments shown in FIG. 11, in each case one or more infrared-heat sources (16) or other known heat sources have been provided instead of the hot-air blower (15) from FIG. 10. These heat sources (16) have been shown as clear circles surrounded by radiation waves.

The machine can contain one heat source (15),(16) and the open bottom side of the heating chamber (13) can have a substantially rectangular shape with rounded corners which is surrounded laterally by side walls (14), as is shown in the uppermost arrangement in FIGS. 10 and 11.

The heating chamber (13) can also have an open bottom side with an arcuate surface which follows the circular periphery of the round brush (10). Preferably, said shape follows the circular periphery over approximately half the circumference. The second and the third arrangements from FIGS. 10 and 11 comprise such a heating chamber (13), with one single heat source (15), (16) and three different heat sources (15), (16) being provided, respectively.

The fourth and the fifth (last) arrangements from FIGS. 10 and 11 comprise a first (13a) and a second heating chamber (13b) laterally surrounded by side walls (14a) and (14b), respectively, and having a respective open bottom side. Each open bottom side takes up a surface with an identical curved shape and the heating chambers (13a), (13b) are arranged next to one another in such a manner that each of their open bottom sides follows a respective part of the circular periphery of the brush (10). In each heating chamber (13a), (13b), it is possible to provide either one single heat source (15),(16) (fourth arrangement) or two heat sources (15),(16) for each heating chamber (13a), (13b).

Instead of two heating chambers (13a), (13b) which are surrounded by separate side walls (14a), (14b) and each have their arcuate open bottom side (the fourth and fifth arrangements in FIGS. 10 and 11), it is also possible to provide one heating chamber (13) which comprises two or more openings in the bottom side which are separated from one another.

The arcuate open bottom sides of the heating chamber (13); (13a), (13b) which follow the circular periphery of the brush (10) at a small intermediate distance, offer the advantage that the distance between the heating chamber(s) (13); (13a),(13b) and the brush (10) can be kept to a minimum. As a result thereof, only a very small amount of time passes between heating the chewing gum remains and cleaning them up with the brush (10) when the machine moves. This ensures that the chewing gum remains are still sufficiently hot to be able to remove them in a very simple manner.

The arrangements shown in FIGS. 10 and 11 in each case comprise a brush (10) with steel wires or strips fitted with a toothed or serrated edge and/or tip and, if desired, with one or more other features which have been indicated above.

1. Brush for removing chewing gum remains and weeds from a surface and in a crevice, consisting of a baseplate provided with at least one set of first hairs and one or more detachable brush parts provided with at least one set of second hairs, in which the first and second hairs form such a cleaning surface that the second hairs are longer than the first hairs at the cleaning surface, wherein one or more first or second hairs are steel strips or wires having a toothed or serrated edge and/or tip.

2. Brush according to claim 1, characterized in that the wires are braided or wound wires.

3. Brush according to claim 1, characterized in that the strips are made from card wire.

4. Brush according to claim 1, characterized in that at least one set of second hairs of the detachable brush parts comprises steel strips or wires.

5. Brush according to claim 1, characterized in that the strips or wires have a width of 2-10 mm, preferably of 2-5 mm.

6. Brush according to claim 1, characterized in that the strips or wires are made from steel with one of the following carbon contents: C60, C75, C100.

7. Brush according to claim 1, characterized in that the strips or wires are made from steel which has undergone an aftertreatment, such as a hardening.

8. Brush according to claim 1, characterized in that the strips or wires are made from a steel alloy, such as for example 10Cr6.

9. Brush according to claim 1, characterized in that the strips or wires comprise titanium, tungsten or an alloy thereof.

10. Brush according to claim 1, characterized in that the strips or wires are provided with a coating, such as for example a coating which comprises tungsten carbide, nickel or chromium.

11. Brush according to claim 1, characterized in that the strips or wires are inserted into holes in the baseplate and/or the brush parts either radially or tangentially or cross-wise.

12. Brush according to claim 1, characterized in that the detachable brush parts are L-, T- or Y-shaped.

13. Brush according to claim 1, characterized in that the detachable brush parts are provided on the baseplate in such a manner that they extend radially between the sets of first hairs

14. Brush according claim 1, characterized in that the detachable brush parts are provided on the baseplate in such a manner that they extend between the sets of first hairs in a way similar to blades.

15. Brush according to claim 1, characterized in that the detachable brush parts are movably arranged with respect to the baseplate.

16. Brush according to claim 1, characterized in that the detachable brush parts can be moved in a rotatable or reciprocating manner.

17. Brush according to claim 1, characterized in that two, three or four detachable brush parts are provided on the baseplate.

18. Brush according to claim 1, characterized in that at least part of the first or the second hairs, respectively, are inserted obliquely into the baseplate or the brush parts, respectively.

19. Brush according to claim 1, characterized in that the brush comprises supply means for supplying hot water or steam to the surface to be cleaned.

20. Brush according to claim 1, characterized in that the supply means are provided for supplying hot water or steam at low pressure.

21. Brush according to claim 1, characterized in that the supply means are provided for applying edge spraying

22. Brush according to claim 1, characterized in that the brush is provided with means to carry out a heating, cooling or freezing pretreatment for removing chewing gum remains, for example by means of a laser or microwave pretreatment, or by means of dry ice.

23. Brush according to claim 1, characterized in that the baseplate is of round design.

24. Machine for removing chewing gum remains from a surface to be cleaned, in which the machine is designed to be moved across the surface and comprises one or more brushes which are designed to move when touching the surface, characterized in that the machine comprises a heat source which is designed to heat the chewing gum remains which are situated on the surface in front of the brushes, viewed in the direction of movement, during the movement of the machine.

25. Machine according to claim 24, characterized in that the machine comprises a heating chamber which is at least partly open on the side facing the surface, in that the heat source is designed to heat the air in the heating chamber or to introduce heated air into the heating chamber, in that the heating chamber is provided on the front of the machine with respect to the brushes so that the open side is situated above a part of the surface which is situated in front of the brushes during the movement of the machine.

26. Machine according to claim 24, characterized in that the heat source comprises an electric resistor and/or a gas burner, and is provided with a blowing device.

27. Machine according to claim 25, characterized in that the heating chamber comprises side walls, the end part or edge part of which facing the surface is made from a flexible material or is provided with a plurality of flexible elements, such as brush hairs which extend towards the surface.

28. Machine according to claim 24, characterized in that the machine comprises at least one brush according to claim 1.

29. Method for removing chewing gum remains from a surface to be cleaned, in which one or more brushes with steel strips according to claim 1 or a machine according to claim 24 is used.
